(19) United States
(12) Patent Application Publication
(10) Pub. No.: US 2021/0172340 A1
(43) Pub. Date: Jun. 10, 2021

(54) TUBE ASSEMBLY

(71) Applicant: MTU Aero Engines AG, Muenchen (DE)

(72) Inventor: John Wilber, Marlborough, CT (US)

(21) Appl. No.: 16/707,026

(22) Filed: Dec. 9, 2019

(51) Int. Cl. F01D 25/24

(52) U.S. Cl. CPC F01D 25/24; F05D 2220/32; F05D 2240/55

(57) ABSTRACT

A tube assembly, in particular for a fluid supply system of a turbomachine, the assembly including a first tube, a second tube, a connection connecting the first and second tube, wherein the connection includes a first sealed spherical joint and a first sealed linear joint.

The present invention refers to a tube assembly, in particular for a fluid supply system of a turbomachine, a turbomachine, in particular a gas turbine, comprising a fluid supply system with the tube assembly and using the tube assembly in such fluid supply system.

### SUMMARY OF THE INVENTION

It is an object of the present invention to improve interconnecting a first tube and a second tube.

The present invention provides a tube assembly and a turbomachine, in particular a gas turbine, comprising a fluid supply system with at least one tube assembly as described herein and using a tube assembly as described herein in a fluid supply system of a turbomachine, in particular a gas turbine respectively.

According to one embodiment of the present invention a tube assembly comprises:

at least two tubes called a first and second tube herein without loss of generality; and

a connection connecting said first and second tube;

wherein said connection comprises:

at least one sealed spherical joint called a first sealed spherical joint herein without loss of generality; and

at least one sealed linear joint called a first sealed linear joint herein without loss of generality.

According to one embodiment the connection combining or comprising at least one sealed spherical joint and at least one sealed linear joint may advantageously allow to compensate for axial displacement (by the linear joint(s)) as well as angular displacement (by the spherical joint(s)) between the (opposite front faces of the) first and second tube.

According to one embodiment the connection comprises a second sealed spherical joint. Additionally or alternatively the connection comprises a second sealed linear joint according to one embodiment.

According to one embodiment the connection combining or comprising at least one additional sealed spherical joint or at least one additional sealed linear joint, in particular at least one additional sealed spherical joint and at least one additional sealed linear joint, may advantageously allow to compensate for planar displacement and/or additional axial or angular displacement between the (opposite front faces of the) first and second tube.

According to one embodiment the second sealed spherical joint is coupled to the first sealed linear joint by the first sealed spherical joint. Additionally or alternatively the first sealed spherical joint is coupled to the second sealed linear joint by the second sealed spherical joint according to one embodiment. According to one embodiment the first sealed linear joint is coupled to the second sealed linear joint by the first and/or second sealed spherical joint. According to one embodiment the first and second sealed spherical joint are supported by the first and second tube via the first and second sealed linear joint.

According to one embodiment this may reduce installation space.

According to one embodiment the second sealed spherical joint is coupled to the first sealed spherical joint by the first and/or second sealed linear joint. According to one embodiment the first and second sealed linear joint are supported by the first and second tube via the first and second sealed spherical joint.

According to one embodiment this may improve kinematic of the connection.

According to one embodiment the first and second sealed spherical joint comprise one common bushing which encompasses a first sealed spherical joint's sealing arranged at the first tube and a second sealed spherical joint's sealing arranged at the second tube. In particular said common bushing may comprise a first surface encompassing the first sealed spherical joint's sealing and a second surface encompassing the second sealed spherical joint's sealing which is integrally formed with or joined to said first surface of the common bushing.

According to one embodiment this may improve stability.

According to one embodiment a front face of the common bushing comprises at least one bulge, preferably at least two, preferably opposite, bulges, for entering the first sealed spherical joint's sealing, preferably perpendicular to its (final) installation orientation. Additionally or alternatively a, in particular opposite, front face of the common bushing comprises at least one bulge, preferably at least two, preferably opposite, bulges, for entering the second sealed spherical joint's sealing, preferably perpendicular to its (final) installation orientation.

According to one embodiment this may improve mounting of said sealing(s).

According to one embodiment the first sealed linear joint comprises a sealing arranged movably at the first tube, preferably movable in axial direction. According to one embodiment the first sealed linear joint comprises the first sealed spherical joint's sealing which is arranged (axially) movably at the first tube. Additionally or alternatively according to one embodiment the second sealed linear joint comprises a sealing arranged movably at the second tube, preferably movable in axial direction. According to one embodiment the second sealed linear joint comprises the second sealed spherical joint's sealing which is arranged (axially) movably at the second tube.

According to one embodiment this may reduce installation space and/or improve stability.

According to one embodiment the first sealed spherical joint comprises a first bushing encompassing a first sealed spherical joint's sealing arranged at the first tube. Additionally or alternatively the second sealed spherical joint comprises a second bushing encompassing a second sealed spherical joint's sealing arranged at the second tube according to one embodiment.

According to one embodiment this may improve kinematic of the connection.

According to one embodiment the first bushing is axially split, wherein at least two axially adjacent parts of such axially split first bushing may be fixed to one another detachably, in particular by form fit or friction fit.

Additionally or alternatively the second bushing is axially split according to one embodiment, wherein at least two axially adjacent parts of such axially split second bushing may be fixed to one another detachably, in particular by form fit or friction fit.

Additionally or alternatively the first sealed spherical joint's sealing is circumferentially split according to one embodiment, preferably comprises two or more ring segments forming a ring together, said ring segments being fixed to one another detachably, in particular by form fit or friction fit, according to one embodiment.

Additionally or alternatively the second sealed spherical joint's sealing is circumferentially split according to one embodiment, preferably comprises two or more ring segments forming a ring together, said ring segments being fixed to one another detachably, in particular by form fit or friction fit, according to one embodiment.

According to one embodiment this may improve mounting of said sealed spherical joint(s).

According to one embodiment the first sealed linear joint comprises a sleeve arranged movably at a shaft, preferably movable in axial direction. According to one embodiment the first sealed linear joint comprises a sleeve arranged (axially) movably at a shaft of the first bushing. Additionally or alternatively according to one embodiment the second sealed linear joint comprises a sleeve arranged movably at a shaft, preferably movable in axial direction. According to one embodiment the second sealed linear joint comprises a sleeve arranged (axially) movably at a shaft of the second bushing. According to one embodiment the sleeve of the first sealed linear joint and the sleeve of the second sealed linear joint are formed by one common sleeve. In particular said common sleeve may comprise a first surface encompassing the first bushing's shaft and a second surface encompassing the second bushing's shaft which is integrally formed with or joined to said first surface of the common sleeve.

According to one embodiment this may reduce installation space and/or improve kinematic and/or stability of the connection.

According to one embodiment the sleeve is circumferentially split, preferably comprises two or more ring segments forming a ring together, said ring segments being fixed to one another detachably, in particular by form fit or friction fit, according to one embodiment.

According to one embodiment this may improve mounting of said sealed linear joint(s).

According to one embodiment at least one of the sealed joints comprises one or more ring seal(s). According to one embodiment the first sealed spherical joint, in particular its sealing, the second sealed spherical joint, in particular its sealing, the first sealed linear joint, in particular its sealing, sleeve or shaft, and/or the second sealed linear joint, in particular its sealing, sleeve or shaft (each) comprises one or more ring seal(s), preferably two or more seals which are arranged sequentially in axial direction. Such ring seal(s) may in particular be a rope or elastomeric seal.

According to one embodiment this may improve fluid-tightness of the tube arrangement or its connection respectively.

According to one embodiment axial movement of the first sealed spherical joint is limited or prohibited by at least one collar, in particular by at least one roll bead, of the first tube. Additionally or alternatively axial movement of the first sealed linear joint is limited by at least one collar, in particular by at least one roll bead, of the first tube according to one embodiment. Additionally or alternatively axial movement of the second sealed spherical joint is limited or prohibited by at least one collar, in particular by at least one roll bead, of the second tube according to one embodiment. Additionally or alternatively axial movement of the second sealed linear joint is limited by at least one collar, in particular by at least one roll bead, of the second tube according to one embodiment.

According to one embodiment this may improve kinematic of the connection and/or stability.

A tube arrangement according to the present invention may be used with great advantage in a fluid supply system for or of a turbomachine, in particular a gas turbine, respectively. Said fluid supply system is a cooling (fluid) system, preferably a (cooling) air supply system, according to one embodiment. The first and second tube of the tube arrangement guide or contain a gaseous fluid, preferably air, more preferably cooling air, more preferably for an active clearance control of the turbomachine, or are adapted or used thereto respectively according to one embodiment. “Sealed” as used herein denotes “fluid-tight” with respect to the fluid which flows through the first and second tube according to one embodiment, thus denoting “air-tight” or “air-sealed” respectively according to one embodiment.

An axial direction mentioned herein may in particular denote a lengthwise of flow-through direction of the first and/or second tube and/or connection. A circumferential direction mentioned herein may in particular denote a circumferential direction of the first and/or second tube.

### BRIEF DESCRIPTION OF THE DRAWINGS

Further features of the present invention are disclosed in the sub-claims and the following description of preferred embodiments. Thereto it is shown, partially schematically, in:

FIG. 1 an axial section of a tube assembly according to a preferred embodiment of the present invention compensating axial displacement;

FIG. 2 the tube assembly of FIG. 1 compensating angular displacement;

FIG. 3 the tube assembly of FIG. 1 compensating planar displacement;

FIG. 4A-C mounting of a first sealed spherical joint's sealing to a common bushing of a first and second sealed spherical joint of the tube assembly of FIG. 1;

FIG. 5 an axial section of a tube assembly according to another preferred embodiment of the present invention compensating axial displacement;

FIG. 6 the tube assembly of FIG. 5 compensating angular displacement;

FIG. 7 the tube assembly of FIG. 5 compensating planar displacement;

FIG. 8A-D mounting of the tube assembly of FIG. 5.

### DETAILED DESCRIPTION

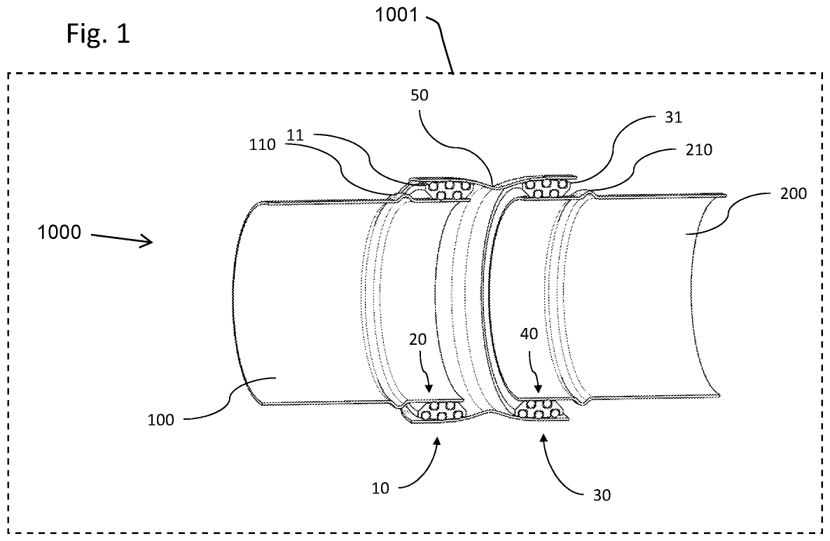

FIG. 1 shows, partially schematically, an axial section of a tube assembly according to a preferred embodiment of the present invention compensating axial displacement (horizontal in FIG. 1). The tube assembly is part of a fluid supply system 1000 of a gas turbine 1001, shown schematically.

The tube assembly comprises a first tube 100, a second tube 200 and a connection connecting the first and second tube, said connection comprising a first sealed spherical joint 10, a first sealed linear joint 20, a second sealed spherical joint 30 constructed in the same way as the first sealed spherical joint 10 and a second sealed linear joint 40 constructed in the same way as the first sealed linear joint 20.

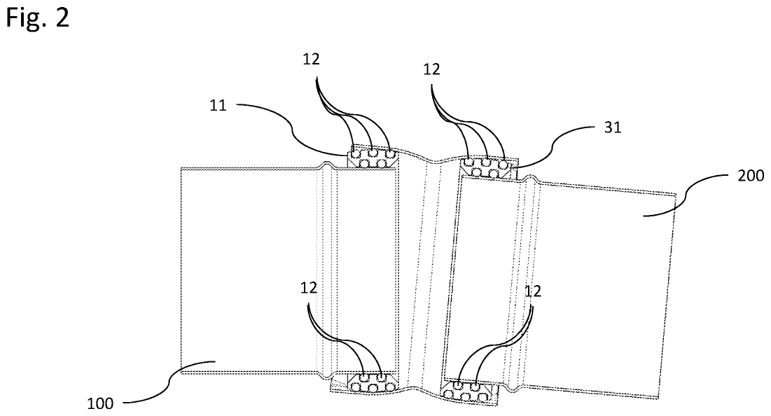

The first sealed spherical joint 10 and first sealed linear joint 20 comprise a common sealing 11 with ring seals 12 (see FIG. 2) at its outer and inner surface which is arranged axially movably at the first tube 100 (“first sealed spherical joint's sealing”).

Accordingly the second sealed spherical joint 30 and second sealed linear joint 40 comprise a common sealing 31 with ring seals 12 (see FIG. 2) at its outer and inner surface which is arranged axially movably at the second tube 200 (“second sealed spherical joint's sealing”).

The second sealed spherical joint 30 is coupled to the first linear joint 20 by the first sealed spherical joint 10, the first sealed spherical joint 10 is coupled to the second sealed linear joint 40 by the second sealed spherical joint 30, and the first sealed linear joint 20 is coupled to the second sealed linear joint 40 by the first and second sealed spherical joint 10, 30 which are supported by the first and second tube 100, 200 via the first and second sealed linear joint 20, 40 and comprise a common bushing 50 encompassing said first sealed spherical joint's sealing 11 arranged at the first tube 100 and said second sealed spherical joint's sealing 31 arranged at the second tube 200.

A roll bead 110 of the first tube 100 and a roll bead 210 of the second tube 200 limit axial movement of said joints.

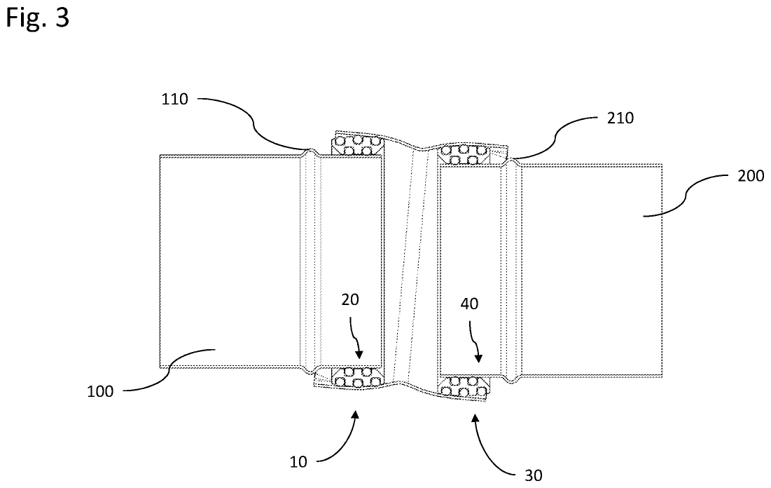

As can be understood from FIGS. 1-3, said connection allows to compensate axial displacement (see FIG. 1: horizontal/axial movement of tubes 100, 200 relative to one another), angular displacement (see FIG. 2: tilt movement of tubes 100, 200 relative to one another) and planar displacement (see FIG. 3: vertical/radial movement of tubes 100, 200 relative to one another).

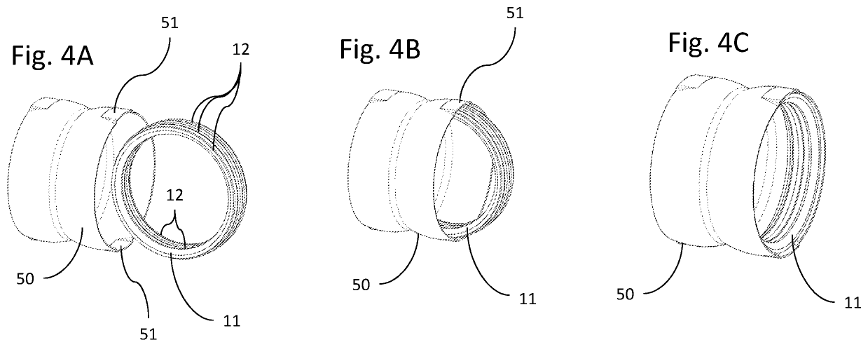

Sequence of FIG. 4A→4B→4C illustrates mounting of the first sealed spherical joint's sealing 11 to common bushing 50.

As can be seen therein, first the first sealed spherical joint's sealing 11 including its ring seals 12 enters opposite bulges 51 at one front face of the common bushing 50 perpendicular to its final installation orientation (FIG. 4A→4B). Then the first sealed spherical joint's sealing 11 is rotated 90° into its final installation orientation (FIG. 4B→4C). The second sealed spherical joint's sealing 31 is installed accordingly afterwards.

Thereafter, the opposing ends of the first and second tube 100, 200 are inserted into the first and second sealed spherical joint's sealing 11, 31 respectively to form the configuration shown in FIG. 1.

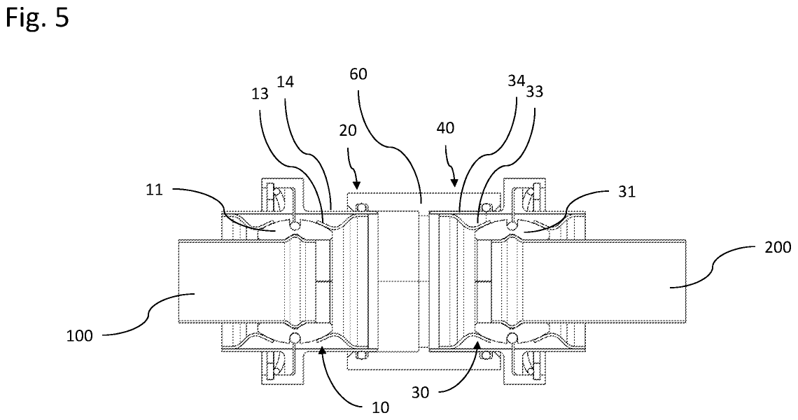

FIG. 5 shows, partially schematically, an axial section of a tube assembly according to another preferred embodiment of the present invention compensating axial displacement (horizontal in FIG. 5). Corresponding features are denoted by identical reference numerals.

The tube assembly of FIG. 5 comprises a first tube 100, a second tube 200 and a connection connecting the first and second tube, said connection comprising a first sealed spherical joint 10, a first sealed linear joint 20, a second sealed spherical joint 30 constructed in the same way as the first sealed spherical joint 10 and a second sealed linear joint 40 constructed in the same way as the first sealed linear joint 20.

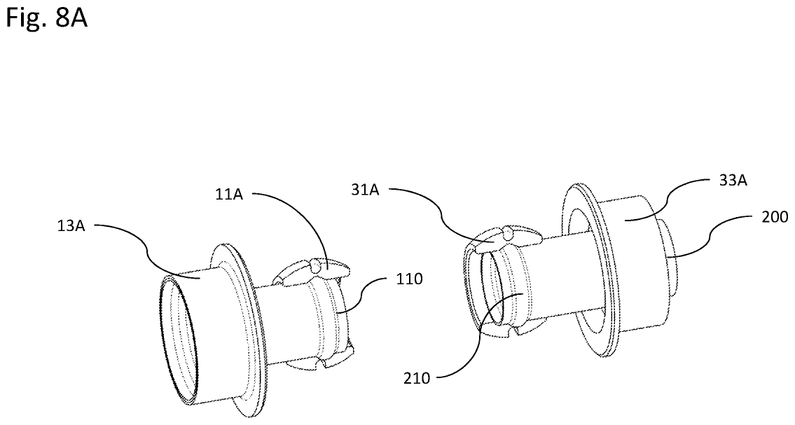

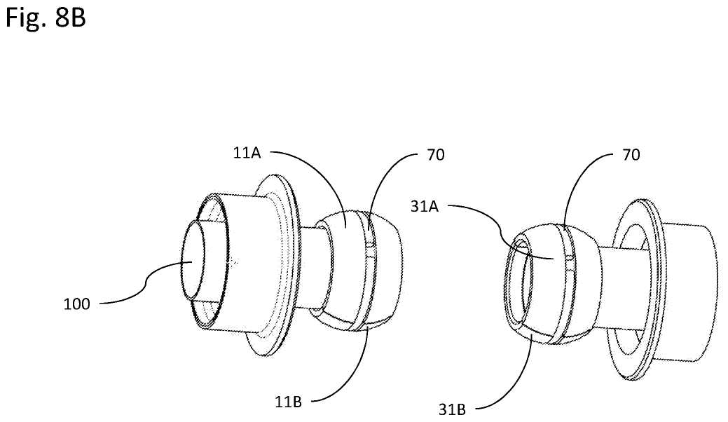

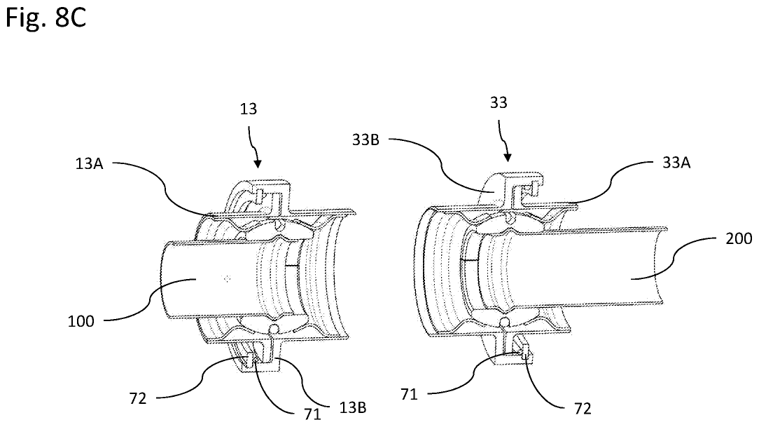

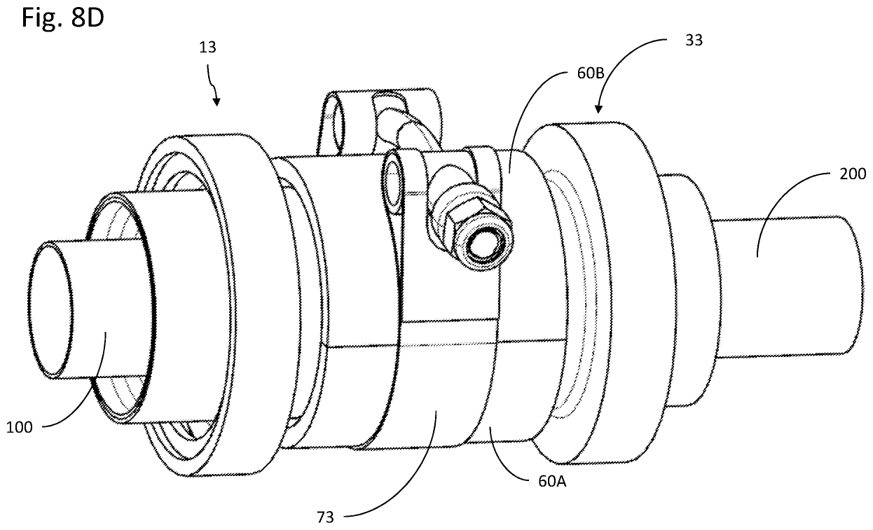

The first sealed spherical joint 10 comprises a first bushing 13 encompassing a first sealed spherical joint's sealing 11 arranged at the first tube 100, wherein axial movement of said first sealed spherical joint('s sealing) is prohibited by a roll bead 110 (see FIG. 8A) of the first tube 100.

Accordingly the second sealed spherical joint 30 comprises a second bushing 33 encompassing a second sealed spherical joint's sealing 31 arranged at the second tube 200, wherein axial movement of said second sealed spherical joint('s sealing) is prohibited by a roll bead 210 (see FIG. 8A) of the second tube 200.

The first sealed linear joint 20 comprises a sleeve 60 arranged axially movably at a shaft 14 of the first bushing 13 and a shaft 34 of the second bushing 33. Thus the second sealed linear joint 40 comprises said (common) sleeve 60 and said shaft 34.

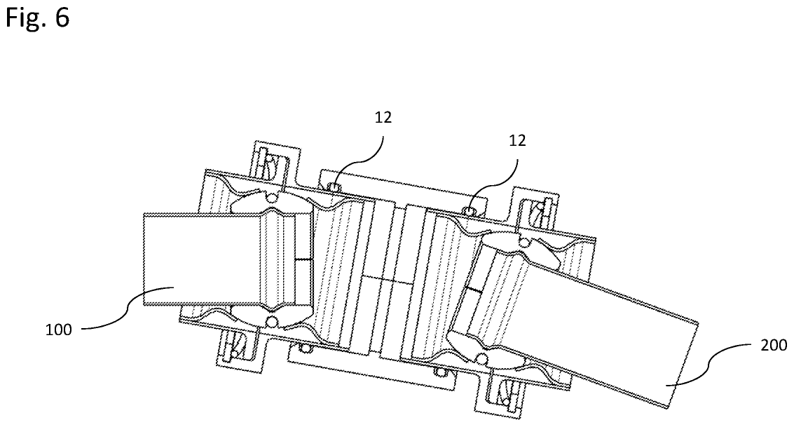

Both sealed linear joints 20, 40 each comprise a ring seal 12 (see FIG. 6) and are supported by the first and second tube 100, 200 via the first and second sealed spherical joint 10, 30. The second sealed spherical joint 30 is coupled to the first sealed spherical joint 10 by the first and second sealed linear joint 20, 40.

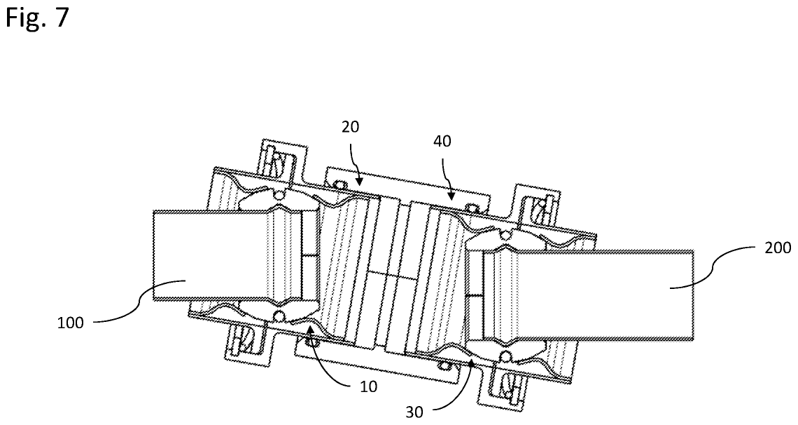

As can be understood from FIGS. 5-7, said connection combining the first and second sealed spherical and linear joint 10, 20, 30 and 40 allows to compensate axial displacement (see FIG. 5: horizontal/axial movement of tubes 100, 200 relative to one another), angular displacement (see FIG. 6: tilt movement of tubes 100, 200 relative to one another) and planar displacement (see FIG. 7: vertical/radial movement of tubes 100, 200 relative to one another). As can be understood from FIG. 5, the sequential combination of the two sealed linear joints 20, 40 increase axial travel, wherein up to the linear spacing apart of tubes 100, 200 shown in FIG. 5 sealing is guaranteed. If both tubes 100, 200 are spaced apart from one another further then in FIG. 5, sealing may be guaranteed by a (seal) motion limiter (not shown).

Sequence of FIG. 8A→8B→8C→8D illustrates mounting of the tube assembly.

As can be seen in FIG. 8A, first the circumferentially split first sealed spherical joint's sealing 11 and the circumferentially split second sealed spherical joint's sealing 31 and one part 13A of the axially split first bushing 13 and one part 33A of the axially split second bushing 33 are arranged at the first and second tube 100, 200 respectively. In FIG. 8A only one ring segment 11A of the first sealed spherical joint's sealing 11 and one ring segment 31A of the second sealed spherical joint's sealing 31 are shown arranged at the first and second tube 100, 200 respectively.

After the other ring segment 11B, 31B is added, the so-formed ring-like circumferentially split first sealed spherical joint's sealing 11 and the circumferentially split second sealed spherical joint's sealing 31 are secured each by a lock ring 70 (see FIG. 8B).

Thereafter, the other part 13B of the axially split first bushing 13 is arranged at the first tube 100 and fixed to part 13A by a wave spring 71 and a lock ring 72. Accordingly the other part 33B of the axially split second bushing 33 is arranged at the second tube 200 and fixed to part 33A by a wave spring 71 and a lock ring 72 (see FIG. 8C).

After arranging the ring seals 12 at shaft 14 of the first bushing 13 and shaft 34 of the second bushing 33 respectively, the parts 60A, 60B of the circumferentially split sleeve 60 are arranged at shaft 14 and shaft 34 and fixed together by a clamp 73 (see FIG. 8D) to form the configuration shown in FIG. 5 (wherein clamp 73 is omitted as in FIGS. 6, 7).

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

“Sealing” as used herein is defined as a seal structure.

### REFERENCE NUMBERS

10 first sealed spherical joint
11 first sealed spherical joint's sealing
11A, 11B ring segment of first sealed spherical joint's sealing
12 ring seal
13 first bushing
13A, 13B part of axially split first bushing
14 shaft
20 first sealed linear joint
30 second sealed spherical joint
31 second sealed spherical joint's sealing
31A, 31B ring segment of second sealed spherical joint's sealing
33 second bushing
33A, 33B part of axially split second bushing
34 shaft
40 second sealed linear joint
50 common bushing
51 bulge
60 sleeve
60A, 60B Part of the circumferentially split sleeve
70 lock ring
71 wave spring
72 lock ring
73 clamp
100 first tube
110 roll bead
200 second tube
210 roll bead

What is claimed is:

1. A tube assembly comprising:
a first tube;
a second tube;
a connection connecting the first and second tube, the connection including a first sealed spherical joint and a first sealed linear joint.

2. The tube assembly according to claim 1, wherein the connection includes a second sealed spherical joint or a second sealed linear joint.

3. The tube assembly according to claim 2, wherein the second sealed spherical joint is coupled to the first sealed linear joint by the first sealed spherical joint.

4. The tube assembly according to claim 2, wherein the second sealed spherical joint is coupled to the first sealed spherical joint by the first sealed linear joint.

5. The tube assembly according to claim 1, wherein the connection includes a second sealed spherical joint and the first and second sealed spherical joints include one common bushing encompassing a first sealing of the first sealed spherical joint arranged at the first tube and a second sealing of the second spherical joint arranged at the second tube.

6. The tube assembly according to claim 5, wherein a front face of the common bushing includes at least one bulge for entering the first sealing or the second sealing.

7. The tube assembly according to claim 1, wherein the first sealed linear joint comprises a first sealing arranged movably at the first tube.

8. The tube assembly according to claim 7, wherein the first sealing is shared with the the first sealed spherical joint.

9. The tube assembly according to claim 1, wherein the first sealed spherical joint includes a first bushing encompassing a first sealing of the first sealed spherical joint arranged at the first tube or a second sealed spherical joint includes a second bushing encompassing a second sealing of the second sealed spherical joint arranged at the second tube.

10. The tube assembly according to claim 9, wherein the first sealed linear joint includes a sleeve arranged movably at a shaft of the first bushing.

11. The tube assembly according to claim 1, wherein the first sealed linear joint includes a sleeve arranged movably at a shaft.

12. The tube assembly according to claim 9, wherein the first or second bushing is axially split or the first or second sealing or a sleeve of the first sealed linear joint is circumferentially split.

13. The tube assembly according to claim 1, wherein at least one of the first sealed spherical joint and the first sealed linear joint includes at least one ring seal.

14. The tube assembly according to claim 1, wherein axial movement of the first sealed spherical or linear joint is limited or prohibited by at least one collar of the first tube.

15. A fluid supply system comprising at least one tube assembly according to claim 1.

16. A turbomachine comprising the fluid supply system according to claim 15

17. A gas turbine comprising the turbomachine according to claim 16.

18. A method of operating the tube assembly according claim 1 in a fluid supply system of a turbomachine, comprising supplying fluid through the tube assembly.

19. The method as recited in claim 18 wherein the turbomachine is a gas turbine.
